(19) United States
(12) Patent Application Publication
(10) Pub. No.: US 2008/0161500 A1
(43) Pub. Date: Jul. 3, 2008

(54) Process for Preparing Silicone Containing Polymers

(75) Inventors: Kurt Stark, Neuhaus (DE); Christian Ochs, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/914,686

(22) PCT Filed: May 11, 2006
(86) PCT No.: PCT/EP2006/004452

§ 371 Date: Nov. 16, 2007

(30) Foreign Application Priority Data
May 20, 2005 (DE) 10 2005 023 404.6

(51) Int. Cl. C08F 8/42

(52) U.S. Cl. 525/342

(57) ABSTRACT

A process for preparing silicone-containing polymers comprises free-radical polymerization of one or more ethylenically unsaturated organic monomers in the presence of copper-free free-radical initiator and one or more polymerization regulators, wherein a polymerization regulator is a silicone which contains at least one aldehyde group.

The invention relates to a process for preparing silicone-containing polymers, with ethylenically unsaturated monomers being subjected to free-radical polymerization in the presence of a regulator from the group of aldehyde-functional silicones.

The prior art has disclosed a series of processes in which organic polymers are modified with silicones by polymerizing the monomers in the presence of a silicone.

EP-B 771826 describes aqueous binders for coatings and adhesives that are based on emulsion polymers of vinyl esters, acrylic or methacrylic esters or vinylaromatics and which comprise as crosslinkers polysiloxanes containing unsaturated radicals, examples being vinyl, acryloyloxy and methacryloyloxy groups. Here the organic monomer is emulsified and polymerized, and after a specific point in time the silicone is added during the reaction. EP-A 943634 describes aqueous lattices for use as coating materials, which are prepared by copolymerizing ethylenically unsaturated monomers in the presence of a silicone resin that contains silanol groups. Here, interpenetrating networks (IPN) are formed between the polymer chains and polysiloxane chains.

EP-A 1095953 describes silicone-grafted vinyl copolymers, which have a carbosiloxane dendrimer grafted onto the vinyl polymers.

The use of vinyl-functionalized silicones is likewise known in the prior art. In the majority of cases the vinyl silicones are reacted with H-siloxanes (organic hydropolysiloxanes) by means of a catalyst (usually Pt compound) as part of a hydrosilylation reaction, as described for example in EP-A 545591.

Polysiloxane-crosslinked styrene-butadiene copolymers are known from U.S. Pat. No. 5,086,141, the crosslinked copolymers being prepared by the suspension polymerization process.

U.S. Pat. No. 5,468,477 relates to vinylsiloxane polymers which are prepared by polymerization in the presence of mercapto-functional silicone. U.S. Pat. No. 5,789,516 describes the use of an initiator combination comprising carbonyl-functional silicone and copper salt for preparing block-type organic silicone copolymers.

The possibilities known from the prior art for the preparation of organic silicone copolymers all have a number of disadvantages. Hydrosilylation reactions of H-siloxanes with vinyl silicones, for example, usually do not proceed quantitatively and always necessitate the presence of Pt catalyst, which contaminates the product and introduces heavy metals. The situation is similar with carbonyl-functional silicones, which are used as an initiator. The copper salt required in that case again carries heavy metals into the end product and leads to impurities which are difficult if not impossible to isolate. Silicones containing mercapto groups are likewise described as regulators in polymerization reactions of organic monomers for preparing organic silicone copolymers. Their use leads to numerous unwanted side reactions on the mercapto group (oxidation reactions or addition reactions, for example). A further disadvantage here is the odour of these compounds, which in some cases are in fact environmentally objectionable. In addition to this, the polymerization rate is significantly lowered, which can go as far as to complete standstill of the polymerization if residual sulphur is present.

Condensation reactions and polymer-analogous reactions on functionalized silicones with organic polymer are usually incomplete and leave unreacted starting materials in the end product. Not least among the reasons for this is the incompatibility of silicones with organic polymers. In the case of emulsion polymerization, one serious disadvantage, for example, is the inadequate attachment and copolymerization of silicone macromers which contain at least one unsaturated polymerizable group to/with organic monomers. EP-A 1354900 avoids this by using a defined silicone mixture. In solution, in contrast, systems of this kind exhibit a significantly improved propensity towards polymerization, so that the use of polyunsaturated silicone macromers results in crosslinked products, which for many applications are unusable.

WO-A 03/085035 avoids this by polymerizing in the presence of a solvent mixture.

The object, accordingly, was to provide silicone-containing polymers which do not feature the abovementioned disadvantages such as unwanted crosslinking, migration tendency and metal contamination.

The invention provides a process for preparing silicone-containing polymers by means of free-radical polymerization of one or more ethylenically unsaturated organic monomers in the presence of copper-free free-radical initiator and one or more polymerization regulators, characterized in that polymerization regulators used are silicones which contain at least one aldehyde group.

Suitable aldehyde-functionalized silicones are linear, branched, cyclic or three-dimensionally crosslinked polysiloxanes having at least 2 repeating siloxane units which contain at least one terminal and/or internal aldehyde group.

Preferred aldehyde-functionalized silicones are those of the general formula (I), with terminal aldehyde group, or of the general formula (II), with internal aldehyde group:

HCO(CH₂)₂—SiR₂O—[SiR₂O—]ₓ—SiR₂—(CH₂)₂—CHO (I), and

R₃Si—O—[SiR₂O—]_{y}—[Si(HCO(CH₂)₂)RO]_{z}—SiR₃ (II),

are used, each R being identical or different and being a monovalent, optionally substituted alkyl radical or alkoxy radical having in each case 1 to 18 carbon atoms, x being ≧1, y being ≧0 and z being ≧1.

Examples of the radicals R are methyl, ethyl, n-propyl, isopropyl, 1-n-butyl, 2-n-butyl, isobutyl, tert-butyl, n-pentyl, isopentyl, neopentyl, tert-pentyl radical, hexyl radicals such as the n-hexyl radical, heptyl radical such as the n-heptyl radical, octyl radicals such as the n-octyl radical and isooctyl radicals such as the 2,2,4-trimethyl-pentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as cyclopentyl, cyclohexyl, cycloheptyl and methylcyclohexyl radicals.

The radical R is preferably a monovalent alkyl radical having 1 to 6 carbon atoms, such as methyl, ethyl, n-propyl, isopropyl, n-butyl, sec-butyl, amyl and hexyl radical, the methyl radical being particularly preferred.

Preferred alkoxy radicals R are those having 1 to 6 carbon atoms, such as methoxy, ethoxy, propoxy and n-butoxy radical, which if desired may also be substituted by oxyalkylene radicals such as oxyethylene or oxymethylene radicals. Particular preference is given to the methoxy and ethoxy radical.

The stated alkyl radicals and alkoxy radical R may where appropriate also be substituted, by for example halogen, epoxy-functional groups, carboxyl groups, keto groups, enamine groups, amino groups, aminoethylamino groups, isocyanato groups, aryloxy groups, alkoxysilyl groups and hydroxyl groups.

In general x is 1 to 10 000, preferably 2 to 1000, more preferably 10 to 500.

In general y is 0 to 1000, preferably 2 to 500.

In general z is 1 to 1000, preferably 1 to 100.

With particular preference y+z is 1 to 1000, most preferably 10 to 500, and the ratio y:z is with particular preference 15:1 to 50:1.

Suitable ethylenically unsaturated organic monomers are one or more monomers from the group consisting of vinyl esters of unbranched or branched alkylcarboxylic acids having 1 to 18 carbon atoms, acrylic esters or methacrylic esters of branched or unbranched alcohols or diols having 1 to 18 carbon atoms, ethylenically unsaturated monocarboxylic and dicarboxylic acids, their salts, and also their amides and N-methylol amides and nitriles, ethylenically unsaturated sulphonic acids and their salts, ethylenically unsaturated heterocyclic compounds, alkyl vinyl ethers, vinyl ketones, dienes, olefins, vinylaromatics and vinyl halides.

Suitable vinyl esters are those of carboxylic acids having 1 to 13 carbon atoms. Preference is given to vinyl acetate, vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 13 carbon atoms, examples being VeoVa9^{R} or VeoVa10^{R} (trade name of the company Resolution). Particular preference is given vinyl acetate.

Suitable monomers from the group of acrylic esters or methacrylic esters are esters of unbranched or branched alcohols or diols having 1 to 15 carbon atoms. Preferred methacrylic esters or acrylic esters are methyl acrylate, methyl methacrylate, ethyl acrylate, ethyl methacrylate, propyl acrylate, propyl methacrylate, isobutyl or n-butyl acrylate, n-butyl methacrylate, tert-butyl acrylate, isobutyl or tert-butyl methacrylate, 2-ethylhexyl acrylate, benzyl (meth)acrylate, 2-hydroxyethyl (meth)acrylate, hydroxypropyl (meth)acrylate, n-hexyl (meth)acrylate, isooctyl (meth)acrylate, isodecyl (meth)acrylate, lauryl (meth)acrylate, methoxyethyl (meth)acrylate, phenoxyethyl (meth)acrylate, isobornyl (meth)acrylate, stearyl (meth)acrylate, cyclohexyl (meth)acrylate, α-chloro acrylic ester and α-cyanoacrylic ester. Particular preference is given to methyl acrylate, methyl methacrylate, n-butyl acrylate, tert-butyl acrylate and 2-ethylhexyl acrylate.

Further examples are functionalized (meth)acrylates and functionalized allyl or vinyl ethers, particularly epoxy-functional ones such as glycidyl acrylate, glycidyl methacrylate, allyl glycidyl ether, vinyl glycidyl ether, or hydroxyalkyl-functional ones such as hydroxyethyl (meth)acrylate.

Examples of suitable ethylenically unsaturated monocarboxylic and dicarboxylic acids, their salts and also their amides and N-methylol amides and nitriles are acrylic acid, methacrylic acid, crotonic acid, itaconic acid, fumaric acid, maleic acid, acrylamide, N-methylolacrylamide, N-methylolmethacrylamide and acrylonitrile and methacrylonitrile. Examples of ethylenically unsaturated sulphonic acids are vinylsulphonic acid and 2-acrylamido-2-methylpropanesulphonic acid. Suitable ethylenically unsaturated heterocyclic compounds are N-vinylpyrrolidone, vinylpyridine, N-vinylimidazole, and N-vinylcaprolactam. Also suitable are cationic monomers such as diallyldimethylammonium chloride (DADMAC), 3-trimethyl-ammoniopropyl(meth)acrylamide chloride (MAPTAC) and 2-trimethylammonioethyl (meth)acrylate chloride.

Preferred vinylaromatics are styrene, α-methylstyrene and vinyltoluene. Preferred vinyl halides are vinyl chloride, vinylidene chloride and vinyl fluoride. The preferred olefins are ethylene and propylene and the preferred dienes are 1,3-butadiene and isoprene.

Preferred alkyl vinyl ethers are ethyl vinyl ether, n-butyl vinyl ether, isobutyl vinyl ether, tert-butyl vinyl ether, cyclohexyl vinyl ether, octadecyl vinyl ether, hydroxybutyl vinyl ether, and cyclohexanedimethanol monovinyl ether.

Further suitable ethylenically unsaturated monomers are vinyl methyl ketone, N-vinylformamide, N-vinyl-N-methylacetamide, vinylcarbazole and vinylidene cyanide.

Suitable monomers are also ethylenically unsaturated silanes. Preference is given to γ-acryloyloxy- and γ-methacryloyloxy-propyltri(alkoxy)silanes, α-methacryloyloxymethyltri(alkoxy)-silanes, γ-methacryloyloxypropylmethyldi(alkoxy) silanes, vinylalkyldi(alkoxy)silanes and vinyltri(alkoxy)silanes, with alkoxy groups that can be used being, for example, methoxy, ethoxy, methoxyethylene, ethoxyethylene, methoxypropylene glycol ether and/or ethoxypropylene glycol ether radicals. Examples of preferred silane-containing monomers are vinyltrimethoxysilane, vinylmethyldimethoxysilane, vinyltriethoxysilane, vinylmethyldiethoxysilane, vinyltris(1-methoxy)isopropoxysilane, methacryloyloxypropyltris(2-methoxy ethoxy)silane, 3-methacryloyloxypropyltrimethoxysilane, 3-methacryloyloxypropylmethyldimethoxysilane and methacryloyloxymethyltrimethoxysilane and also mixtures thereof.

Further examples of suitable monomers are precrosslinking comonomers such as polyethylenically unsaturated comonomers, examples being divinyl adipate, divinylbenzene, diallyl maleate, allyl methacrylate, butanediol diacrylate or triallyl cyanurat, or postcrosslinking comonomers, examples being acrylamidoglycolic acid (AGA), methylacrylamidoglycolic acid methyl ester (MAGME), N-methylolacrylamide (NMA), N-methylol-methacrylamide, N-methylolallylcarbamate, alkyl ethers such as the isobutoxy ether or esters of N-methylolacrylamide, of N-methylolmethacrylamide and of N-methylolallylcarbamate.

The polymerization of the ethylenically unsaturated organic monomers can also take place in the presence of silicone macromer.

Suitable silicone macromers are linear, branched, cyclic and three-dimensionally crosslinked silicones (polysiloxanes) having at least 5 repeating siloxane units and containing at least one free-radically polymerizable functional group. The chain length is preferably 10 to 10 000 repeating siloxane units. Ethylenically unsaturated groups such as alkenyl groups are preferred polymerizable functional groups.

Preferred silicone macromers are silicones having the general formula (III) R¹ₐR₃₋ₐSiO(SiR₂O)ₙSiR₃₋ₐR¹ₐ, R being identical or different and being a monovalent, optionally substituted, alkyl radical or alkoxy radical having in each case 1 to 18 carbon atoms, R¹ being a polymerizable group, a being 0 or 1, and n being=5 to 10 000.

Examples of radicals R in the general formula R¹ₐR₃₋ₐSiO(SiR₂O)ₙSiR₃₋ₐR¹ₐ (III) are methyl, ethyl, n-propyl, isopropyl, 1-n-butyl, 2-n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical and isooctyl radicals such as the 2,2,4-trimethyl-pentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as cyclopentyl, cyclohexyl, cycloheptyl and methylcyclohexyl radicals. Preferably the radical R is a monovalent hydrocarbon radical having 1 to 6 carbon atoms, such as methyl, ethyl, n-propyl, isopropyl, n-butyl, sec-butyl, amyl and hexyl radical, the methyl radical being particularly preferred.

Preferred alkoxy radicals R are those having 1 to 6 carbon atoms such as methoxy, ethoxy, propoxy and n-butoxy radical, which if desired may also be substituted by oxyalkylene radicals such as oxyethylene or oxymethylene radicals. Particular preference is given to the methoxy and ethoxy radical. The stated alkyl radicals and alkoxy radicals R may where appropriate also be substituted, for example by halogen, mercapto groups, epoxy-functional groups, carboxyl groups, keto groups, enamine groups, amino groups, aminoethylamino groups, isocyanato groups, aryloxy groups, alkoxysilyl groups and hydroxyl groups.

Suitable polymerizable groups R¹ are alkenyl radicals having 2 to 8 carbon atoms. Examples of such polymerizable groups are the vinyl, allyl, butenyl, and also acryloyloxyalkyl and methacryloyloxyalkyl group, the alkyl radicals containing 1 to 4 carbon atoms. Preference is given to the vinyl group, 3-methacryloyloxypropyl, (meth)acryloyloxymethyl and 3-acryloyl-oxypropyl group.

Particular preference is given to α,ω-divinylpolydimethylsiloxanes, α,ω-di(3-acryloyloxypropyl)polydimethylsiloxanes and α,ω-di(3-methacryloyloxypropyl)polydimethylsiloxanes. In the case of the silicones substituted only once by unsaturated groups, particular preference is given to α-monovinylpolydimethylsiloxanes, α-mono(3-acryloyloxypropyl)polydimethylsiloxanes, α-mono(acryloyloxymethyl)polydimethylsiloxanes, α-mono(methacryloyloxymethyl)polydimethylsiloxanes and α-mono(3-methacryloyloxypropyl)polydimethylsiloxanes. In the case of the monofunctional polydimethylsiloxanes there is an alkyl or alkoxy radical located at the other end of the chain, such as a methyl or butyl radical.

Particular preference is also given to mixtures of linear or branched divinylpolydimethylsiloxanes with linear or branched monovinylpolydimethylsiloxanes and/or unfunctionalized polydimethylsiloxanes (the latter possessing no polymerizable group). The vinyl groups are located at the chain end. Examples of mixtures of this kind are silicones of the solvent-free Dehesive® 6 series (branched) or Dehesive® 9 series (unbranched) from Wacker-Chemie GmbH. In the case of the binary or ternary mixtures the fraction of the unfunctionalized polydialkylsiloxanes is not more than up to 15% by weight, preferably up to 5% by weight, the fraction of the monofunctional polydialkylsiloxanes is up to 50% by weight, and the fraction of the difunctional polydialkylsiloxanes is at least 50% by weight, preferably at least 60% by weight, based in each case on the total weight of the siloxane macromer.

The most preferred silicone macromers are α,ω-divinylpolydimethylsiloxanes, α-mono(3-methacryloyloxypropyl)poly-dimethylsiloxanes and α,ω-di(3-methacryloyloxypropyl)-polydimethylsiloxanes. The silicone macromers are used generally in an amount of 0.1% to 40% by weight, preferably 1.0% to 20% by weight, based in each case on the total weight of the monomers.

Particular preference is given to monomers or mixtures comprising one or more monomers from the group consisting of vinyl acetate, vinyl esters of α-branched monocarboxylic acids having 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene and silicone macromer.

Maximum preference is given to vinyl acetate and mixtures of vinyl acetate with silicone macromer;

mixtures of vinyl acetate, a vinyl ester of α-branched monocarboxylic acids having 9 to 11 carbon atoms and/or ethylene and, if desired, silicone macromer;
mixtures of n-butyl acrylate with 2-ethylhexyl acrylate and/or methyl methacrylate and, if desired, silicone macromer;
mixtures of styrene with one or more monomers from the group of methyl acrylate, ethyl acrylate, propyl acrylate, n-butyl acrylate and 2-ethylhexyl acrylate and, if desired, silicone macromer;
mixtures of vinyl acetate with one or more monomers from the group of methyl acrylate, ethyl acrylate, propyl acrylate, n-butyl acrylate and 2-ethylhexyl acrylate and, if desired, ethylene and, if desired, silicone macromer.

The free-radically initiated polymerization of the ethylenically unsaturated monomers may in principle take place by any polymerization process known for this purpose, such as bulk polymerization, solution polymerization, precipitation polymerization, suspension polymerization in water, and emulsion polymerization in water.

The polymerization temperature is in general 30° C. to 100° C., preferably 50° C. to 90° C. When copolymerizing gaseous comonomers such as ethylene, 1,3-butadiene or vinyl chloride it is also possible to operate under superatmospheric pressure, in general of between 1 bar and 100 bar.

The polymerization is initiated using the customary water-soluble or monomer-soluble/oil-soluble initiators or redox initiator combinations. Examples of water-soluble initiators are the sodium, potassium and ammonium salts of peroxodisulphuric acid, hydrogen peroxide, tert-butyl hydro-peroxide, potassium peroxodiphosphate, cumene hydroperoxide, isopropylbenzene monohydroperoxide, or water-soluble azo initiators (such as Wako V-50).

Examples of monomer-soluble initiators are dicetyl peroxydicarbonate, di(2-ethylhexyl)peroxydicarbonate, 1,1-bis(tert-butylperoxy)-3,3,5-trimethylcyclohexane, di(4-tert-butylcyclohexyl) peroxydicarbonate, dicyclohexyl peroxydicarbonate, dibenzoyl peroxide, dilauroyl peroxide, tert-amyl peroxypivalate, tert-butyl perneodecanoate, tert-butyl per-2-ethylhexanoate, tert-butyl perpivalate or azo initiators such as AIBN.

The stated initiators are used generally in an amount of 0.01% to 10.0% by weight, preferably 0.1% to 1.0% by weight, based in each case on the total weight of the monomers. Redox initiators used are combinations of the stated initiators with reducing agents. Suitable reducing agents are the sulphites and bisulphites of the alkali metals and of ammonium, an example being sodium sulphite, the derivatives of sulphoxylic acid such as zinc formaldehyde-sulphoxylate or alkali metal formaldehyde-sulphoxylate, an example being sodium hydroxymethanesulphinate, and ascorbic acid. The amount of reducing agent is generally 0.01% to 10.0% by weight, preferably 0.1% to 1.0% by weight, based in each case on the total weight of the monomers.

In the case of solution polymerization use is made of organic solvents such as, for example, tetrahydrofuran, diethyl ether, petroleum ether, methyl acetate, ethyl acetate, methyl ethyl ketone, acetone, isopropanol, propanol, ethanol, methanol, cyclohexane, toluene or benzene.

In the case of the stated processes of suspension polymerization and emulsion polymerization the reaction is conducted in the presence of surface-active substances such as protective colloids and/or emulsifiers. Suitable protective colloids are, for example, partly hydrolysed polyvinyl alcohols, polyvinylpyrrolidones, polyvinyl acetals, starches, celluloses and their carboxymethyl, methyl, hydroxyethyl and hydroxypropyl derivatives.

Suitable emulsifiers are anionic, cationic and nonionic emulsifiers, examples being anionic surfactants, such as alkyl sulphates having a chain length of 8 to 18 carbon atoms, alkyl or alkylaryl ether sulphates having 8 to 18 carbon atoms in the hydrophobic radical and up to 60 ethylene oxide or propylene oxide units, alkyl- or alkylaryl sulphonates having 8 to 18 carbon atoms, full esters and monoesters of sulphosuccinic acid with monohydric alcohols or alkylphenols, or nonionic surfactants such as alkyl polyglycol ethers or alkylaryl polyglycol ethers having up to 60 ethylene oxide and/or propylene oxide units.

The monomers can be introduced in their entirety in the initial charge, added by metering in their entirety, or included in fractions in the initial charge, with the remainder being metered in after the polymerization has been initiated. The metered feeds may be conducted separately (in space and in time) or some or all of the components to be metered can be emulsified beforehand and then added.

The aldehyde-functional silicones used as polymerization regulators can be included in their entirety in the initial charge, metered in their entirety, or included in fractions in the initial charge, with the remainder being metered in. It is preferred to include one portion in the initial charge and to meter in the remainder. Particular preference is given to adding regulators and monomers in such a way that their molar ratio remains the same during the polymerization. This measure produces a homogeneous molecular weight distribution and a homogeneous polymer. In general the aldehyde-functional silicones are used in an amount of 0.1% to 40% by weight, preferably 1.0% to 20% by weight, based in each case on the total weight of the monomers.

Besides the aldehyde-functional silicone regulators used it is also possible in addition to employ further regulators based on silane-containing compounds or on aldehydes.

After the end of the polymerization it is possible to remove residual monomers and volatile components by means of postpolymerization, distillation, the passage of inert gas and/or steam, or a combination of these measures.

To prepare polymer powders which are redispersible in water it is possible to carry out conventional spray drying of the aqueous dispersions, which are accessible by means of emulsion polymerization and suspension polymerization, spray-drying taking place following the addition of protective colloids as spraying aids.

Where vinyl ester monomers are employed, especially vinyl acetate, the resulting organic silicone copolymers can be hydrolysed to silicone-containing polyvinyl alcohols. The polyvinyl ester starting materials employed in this case are preferably prepared by the bulk polymerization or solution polymerization process. To prepare the hydrolysis products the silicone-containing polymer is hydrolysed, in a way which is known to the skilled person, in alcoholic solution, using the typical acidic or alkaline catalysts. Suitable solvents are aliphatic alcohols having 1 to 6 carbon atoms, preferably methanol or ethanol. Alternatively the hydrolysis can be carried out in a mixture of water and aliphatic alcohol. Examples of acidic catalysts are strong mineral acids, such as hydrochloric acid or sulphuric acid, or strong organic acids, such as aliphatic or aromatic sulphonic acids. Preference is given to using alkaline catalysts. These are, for example, the hydroxides, alkoxides and carbonates of alkali metals or alkaline earth metals. The catalysts are used in the form of their aqueous or alcoholic solutions. The amounts of alkaline catalyst employed are generally 0.2 to 20.0 mol %, based on organic silicone copolymer.

The hydrolysis is conducted generally at temperatures from 20° C. to 70° C., preferably 30° C. to 60° C. Addition of the catalyst solution initiates the transesterification. When the desired degree of hydrolysis has been reached, generally between 40 and 100 mol %, the transesterification is discontinued. In the case of acid-catalysed transesterification, discontinuation is accomplished by adding alkaline reagents. In the case of the preferred alkali-catalysed transesterification the discontinuation—i.e. the neutralization—is accomplished by addition of acid reagents, such as carboxylic acids or mineral acids. After the end of the hydrolysis reaction the product is separated from the liquid phase. This can be done by means of customary apparatus for solid/liquid separation, such as by centrifugation or filtration, for example.

In a subsequent step the silicone-containing polyvinyl alcohols can additionally be acetalized with aldehydes to silicone-containing polyvinyl acetals. For acetalization the partly or fully hydrolysed silicone-containing polyvinyl esters are preferably taken up in an aqueous medium. It is usual to set a solids content of 5% to 40% by weight in the aqueous solution. The acetalization takes place in the presence of acidic catalysts such as hydrochloric acid, sulphuric acid, nitric acid or phosphoric acid. The pH of the solution is preferably set at values <1 by addition of hydrochloric acid. Following addition of the catalyst the solution is cooled to preferably −10° C. to +20° C. The acetalization reaction is initiated by addition of the aldehyde fraction.

Preferred aldehydes from the group of the aliphatic aldehydes having 1 to 15 carbon atoms are formaldehyde, acetaldehyde, propionaldehyde, and, most preferably, butyraldehyde, or a mixture of butyraldehyde and acetaldehyde. Examples of aromatic aldehydes which can be used include benzaldehyde or its derivatives. The amount of aldehyde added is guided by the desired degree of acetalization. Since the acetalization proceeds with virtually complete conversion, the amount added can be determined by simple stoichiometric calculation. When the addition of the aldehyde has come to an end, the acetalization is completed by heating of the batch at 10° C. to 60° C. and stirring for a number of hours, preferably 1 to 6 hours, and the reaction product, in the form of a powder, is isolated by filtration with a downstream washing step.

The silicone-containing polymers obtainable with this invention can be employed very profitably in the fields of application that are typical for such polymers.

The silicone-containing polymers and solutions thereof that are obtainable by means of bulk, solution, emulsion and suspension polymerization possess suitability as release agents and coating materials: for example, for producing adhesive (non-adhesive) coatings in release coating. They are also suitable for coating textile, paper, plastics (e.g. films), wood and metals: for example, as a protective coating or as an antifouling coating. Another field of use is that of architectural preservation, particularly for producing weathering-resistant coatings or sealants. They are further suitable as modifiers and hydrophobicizers and as cosmetics additives, such as additives to hair sprays, hairsetting compositions, creams, shampoos or lotions. Further applications are those in adhesives, as binders in paints and printing inks, and in crosslinkable sealants.

Aqueous dispersions or redispersible dispersion powders can be used, for example, in chemical products for construction, where appropriate in conjunction with hydraulically setting binders such as cements (Portland, aluminate, trass, slag, magnesia or phosphate cement), gypsum, waterglass, for producing construction adhesives, especially tile adhesives and adhesives for exterior insulation and finishing systems, renders, trowelling compounds, trowel-applied flooring compounds, levelling compounds, non-shrink grouts, jointing mortars and paints; and also as binders for coating materials and adhesives or as coating materials and binders for textiles, plastics, metals, fibers, wood and paper.

The problems addressed at the outset relating to the preparation of silicone-containing polymers can be solved through the use of silicones which carry aldehyde groups. In the case of free-radical emulsion polymerization the attachment of organic monomers is improved; in the case of use in suspension polymerization there is likewise very good attachment, and non-crosslinked products are formed, since the silicone functionalized with aldehyde groups exerts a very good regulating effect.

In particular, however, it is possible with the use of these aldehyde-functional silicones to solve the crosslinking problem affecting free-radical solution polymerization, when polyunsaturated silicone macromers are polymerized with organic monomers.

Thus, with the aldehyde-functional silicones, in the case of free-radical polymerization reactions, starting materials are available from which it is possible with great simplicity to prepare organic silicone copolymers exhibiting a very advantageous profile of properties. For example, furthermore, it is also possible, when using appropriate mixtures of silicone macromers and aldehyde-functional silicones, to vary the molecular weight, the viscosity, the degree of crosslinking and the mechanical properties of the organic silicone copolymer within a broad extent.

The examples below serve to illustrate the invention in more detail without restricting it in any way whatsoever.

### EXAMPLES

### Regulator

### Aldehyde-Functional Silicone

α,ω-Di-aldehyde-functionalized silicone oil with about 59 repeating SiOMe₂ units. Manufacturer: Wacker-Chemie GmbH

### Silicone Macromer:

Polydimethylsiloxane with about 100 repeating SiOMe₂ units, α,ω-divinyl-functionalized (VIPO 200). Manufacturer: Wacker-Chemie GmbH

### Comparative Example 1

### Without Regulator, with Silicone Macromer

A 1 l stirred glass pot with anchor stirrer, reflux condenser and metering means was charged with 337.11 g of ethyl acetate, 8.9 g of VIPO 200, 0.77 g of PPV (tert-butyl perpivalate, 75% strength solution in aliphatics) and 35.64 g of vinyl acetate. The initial charge was subsequently heated to 70° C. at a stirrer speed of 150 rpm.

After the internal temperature of 70° C. had been reached, the initiator feed (60.14 g of ethyl acetate and 2.98 g of PPV) was commenced at a rate of 13.6 ml/h. Ten minutes after the commencement of the initiator feed, the monomer feed (71.29 g of VIPO 200 and 285.11 g of vinyl acetate) was run in at a rate of 95 ml/h.

The initiator feed was to have extended over a period of 310 minutes; the monomer feed was to have ended 60 minutes earlier. However, after a metering time of just 145 minutes for the monomer feed, there was a marked crosslinking and, in tandem therewith, a drastic increase in viscosity, and so the batch was terminated (i.e. the feeds were stopped) prematurely, since adequate stirring was no longer possible.

Following the discontinuation, polymerization was continued at 70° C. for 60 minutes. The polymer solution obtained was subsequently concentrated to dryness in a rotary evaporator with heating. Cooling to room temperature gave a turbid, crosslinked resin.

Analyses: SC: 98.7%, viscosity (Höppler, 10% strength solution in ethyl acetate)=56.9 mPas, SEC M_{w}=277 000, Mₙ=16 800, polydispersity=16.5; glass transition temperature (Tg): Tg=31.3° C.; K value (1% strength solution in acetone)=38.3

### Comparative Example 2

### Without Regulator, without Silicone macromer

A 1 l stirred glass pot with anchor stirrer, reflux condenser and metering means was charged with 343.35 g of ethyl acetate, 0.78 g of PPV (tert-butyl perpivalate, 75% strength solution in aliphatics) and 45.37 g of vinyl acetate. The initial charge was subsequently heated to 70° C. at a stirrer speed of 150 rpm.

After the internal temperature of 70° C. had been reached, the initiator feed (61.25 g of ethyl acetate and 3.03 g of PPV) was commenced at a rate of 13.8 ml/h. Ten minutes after the commencement of the initiator feed, the monomer feed (362.99 g of vinyl acetate) was run in at a rate of 98 ml/h. The initiator feed extended over a period of 310 minutes; the monomer feed ended 60 minutes earlier. After the end of the initiator feed, polymerization was continued at 70° C. for 60 minutes. The polymer solution obtained was subsequently concentrated to dryness in a rotary evaporator with heating. Cooling to room temperature gave a transparent resin.

Analyses: SC: 99.6%, viscosity (Höppler, 10% strength solution in ethyl acetate)=2.6 mPas, SEC M_{w}=41 000, Mₙ=15 300, polydispersity=2.7; glass transition temperature (Tg): Tg=35.5° C.; K value (1% strength solution in acetone)=19.6

### Inventive Example 3

### With Regulator and Silicone Macromer

A 1 l stirred glass pot with anchor stirrer, reflux condenser and metering means was charged with 211.02 g of ethyl acetate, 0.48 g of PPV (tert-butyl perpivalate, 75% strength solution in aliphatics), 2.79 g of regulator (α,ω-dialdehyde-PDMS), 2.79 g of VIPO 200 and 22.31 g of vinyl acetate. The initial charge was subsequently heated to 70° C. at a stirrer speed of 150 rpm. After the internal temperature of 70° C. had been reached, the initiator feed (37.65 g of ethyl acetate and 1.86 g of PPV) was commenced at a rate of 8.5 ml/h. Ten minutes after the commencement of the initiator feed, the monomer feed (22.31 g of α,ω-dialdehyde-PDMS regulator, 22.31 g of VIPO 200 and 178.47 g of vinyl acetate) was run in at a rate of 59 ml/h. The initiator feed extended over a period of 310 minutes; the monomer feed ended 60 minutes earlier. After the end of the initiator feed, polymerization was continued at 70° C. for 60 minutes. The polymer solution obtained was subsequently concentrated to dryness in a rotary evaporator with heating. Cooling to room temperature gave a slightly turbid resin.

Analyses: SC: 99.4%, viscosity (Höppler, 10% strength solution in ethyl acetate)=4.5 mPas, SEC M_{w}=112 000, Mₙ=22 200, polydispersity=5.0; glass transition temperature (Tg): Tg=30.2° C.; K value (1% strength solution in acetone)=25.8; composition of the organic silicone copolymer according to ¹H NMR spectroscopy: 78.34% by weight PVAc, 21.66% by weight silicone

### Inventive Example 4

### With Regulator, without Silicone Macromer

A 1 l stirred glass pot with anchor stirrer, reflux condenser and metering means was charged with 211.35 g of ethyl acetate, 0.48 g of PPV (tert-butyl perpivalate, 75% strength solution in aliphatics), 5.58 g of regulator (α,ω-dialdehyde-PDMS) and 22.35 g of vinyl acetate. The initial charge was subsequently heated to 70° C. at a stirrer speed of 150 rpm. After the internal temperature of 70° C. had been reached, the initiator feed (37.71 g of ethyl acetate and 1.87 g of PPV) was commenced at a rate of 8.5 ml/h. Ten minutes after the commencement of the initiator feed, the monomer feed (44.69 g of α,ω-dialdehyde-PDMS regulator and 178.75 g of vinyl acetate) was run in at a rate of 59 ml/h. The initiator feed extended over a period of 310 minutes; the monomer feed ended 60 minutes earlier. After the end of the initiator feed, polymerization was continued at 70° C. for 60 minutes. The polymer solution obtained was subsequently concentrated to dryness in a rotary evaporator with heating. Cooling to room temperature gave an almost transparent resin.

Analyses: SC: 99.3%, viscosity (Höppler, 10% strength solution in ethyl acetate)=2.1 mPas, SEC M_{w}=32 500, Mₙ=12 000, polydispersity=2.7; glass transition temperature (Tg): Tg=29.4° C.; K value (1% strength solution in acetone)=17.1; composition of the organic silicone copolymer according to ¹H NMR spectroscopy: 79.00% by weight PVAc, 21.00% by weight silicone

### Evaluation of Results of Analysis:

In Comparative Example 2, vinyl acetate was polymerized in ethyl acetate to form polyvinyl acetate, giving a resin having a viscosity of 2.6 mPas (10% in EtAc). Comparative Example 2 can be regarded as a blank value without silicone components. In Comparative Example 1, as compared with Comparative Example 2 (blank value), as well as vinyl acetate (VAc) (80% by weight) a silicone macromer was used which had 2 unsaturated polymerizable groups (20% by weight), the polymerization process remaining unchanged. Polymerization gave a crosslinked, swollen and turbid product which was unusable; the feeds could not be completed. The organic silicone copolymer had a viscosity of 56.9 mPas (10% in EtAc), which was approximately 22 times the blank value from Comparative Example 2.

Inventive Example 3 demonstrates that the crosslinking can be avoided by adding aldehyde-functional silicones in the polymerization of polyunsaturated silicone macromers. With a mixture of 10% by weight aldehyde-functional silicone and 10% by weight diunsaturated silicone macrometer, and with 80% by weight VAc, the organic silicone copolymer present was not crosslinked and was markedly more transparent, with a viscosity (10% in EtAc) of now only 4.5 mPas, which is only 1.7 times that of the blank value from Comparative Example 2.

In comparison to Comparative Example 1 the viscosity (10% in EtAc) decreased by a factor of 12.6 for the batch from Inventive Example 3.

The excellent regulating action of aldehyde-functional silicones and hence their particular suitability for use as polymerization regulators for preparing organic silicone copolymers is underlined by Inventive Example 4. In that case 20% by weight of aldehyde-functional silicone were polymerized with 80% by weight of VAc. This gave a virtually transparent resin having a viscosity (10% in EtAc) of only 2.1 mPas. In comparison to the blank value from Comparative Example 2 the viscosity here is indeed even lower. Since a virtually transparent resin (in contrast to Comparative Example 1) was obtained, the use of aldehyde-functional silicones evidently also resulted in better compatibility between organic polymer component and silicone component. Phase separation is markedly restricted or even virtually avoided, which is a further advantage for the use of aldehyde-functional silicones in free-radical polymerization reactions.

¹H NMR investigations also demonstrate the good regulatory effect of aldehyde-functional silicones when used in free-radical polymerization reactions. For instance, in the case of the reactions in Inventive Examples 3 and 4, it was apparent that, following polymerization, an average of more than 80% of the aldehyde functions originally present in the molecule have disappeared, since the hydrogen atom in the said function has participated in transfer reactions.

1.-20. (canceled)

21. A process for preparing silicone-containing polymers comprises free-radically polymerizing one or more ethylenically unsaturated organic monomers in the presence of a copper-free free-radical initiator and one or more polymerization regulators, wherein at least one polymerization regulator is a branched, cyclic or three-dimensionally crosslinked polysiloxane having at least 2 repeating siloxane units and which contains at least one terminal and/or internal aldehyde group or a silicone of the formulae
HCO(CH₂)₂—SiR₂O—[SiR₂O—]ₓ—SiR₂—(CH₂)₂—CHO (I), or
R₃Si—O—[SiR₂O—]_{y}—[Si(HCO(CH₂)₂)RO]_{z}—SiR₃ (II),
each R being an identical or different monovalent, optionally substituted alkyl radical or alkoxy radical having 1 to 18 carbon atoms, x being ≧1, y being >0 and z being ≧1.

22. The process of claim 21, wherein the radical R is a monovalent alkyl radical or monovalent alkoxy radical having 1 to 6 carbon atoms.

23. The process of claim 21, wherein x=1 to 10,000, y=0 to 1000 and z=1 to 1000.

24. The process of claim 21, wherein ethylenically unsaturated organic monomers polymerized comprise one or more monomers selected from the group consisting of vinyl esters of unbranched or branched alkylcarboxylic acids having 1 to 18 carbon atoms, acrylic esters or methacrylic esters of branched or unbranched alcohols or diols having 1 to 18 carbon atoms, ethylenically unsaturated monocarboxylic and dicarboxylic acids, their salts, and also their amides and N-methylol amides and nitriles, ethylenically unsaturated sulphonic acids and their salts, ethylenically unsaturated heterocyclic compounds, alkyl vinyl ethers, vinyl ketones, dienes, olefins, vinylaromatics and vinyl halides.

25. The process of claim 24, wherein ethylenically unsaturated organic monomers polymerized comprise
one or more monomers selected from the group consisting of vinyl acetate and mixtures of vinyl acetate with silicone macromer;
mixtures of vinyl acetate, a vinyl ester of α-branched monocarboxylic acids having 9 to 11 carbon atoms and/or ethylene and optionally silicone macromer;
mixtures of n-butyl acrylate with 2-ethylhexyl acrylate and/or methyl methacrylate and, if desired, silicone macromer;
mixtures of styrene with one or more monomers selected from the group consisting of methyl acrylate, ethyl acrylate, propyl acrylate, n-butyl acrylate and 2-ethylhexyl acrylate and, if desired, silicone macromer; or
mixtures of vinyl acetate with one or more monomers from the group of methyl acrylate, ethyl acrylate, propyl acrylate, n-butyl acrylate and 2-ethylhexyl acrylate and, if desired, ethylene and, if desired, silicone macromer.

26. The process of claim 21, wherein the polymerization of the ethylenically unsaturated organic monomers takes place in the presence of at least one silicone macromer selected from the group consisting of linear, branched, cyclic and three-dimensionally crosslinked silicones having at least 5 repeating siloxane units and containing at least one free-radically polymerizable functional group.

27. The process of claim 26, wherein at least one silicone macromer has the formula R¹ₐR₃₋ₐSiO(SiR₂O)ₙSiR₃₋ₐR¹ₐ, R being identical or different and being a monovalent, optionally substituted, alkyl radical or alkoxy radical having 1 to 18 carbon atoms, R¹ being a polymerizable group, a being 0 or 1, and n being=5 to 10,000.

28. The process of claim 21, wherein the silicone-containing polymer is a vinyl ester polymer, further comprising hydrolyzing the vinyl ester polymer to form a hydroliysis product.

29. The process of claim 28, further comprising acetalizing the hydrolysis product.

30. The process of claim 21, wherein the silicone-containing polymers are obtained by polymerization in water, further comprising spray-drying to form a redispersible polymer powder.
